(19) United States
(12) Patent Application Publication
(10) Pub. No.: US 2013/0150125 A1
(43) Pub. Date: Jun. 13, 2013

(54) Electronic System and Electronic Device Having the Same

(71) Applicant: ASUSTek COMPUTER INC., Taipei (TW)

(72) Inventors: Chang-Yi Tseng, Taipei (TW); Chung-Yuan Kuang, Taipei (TW)

(73) Assignee: ASUSTEK COMPUTER INC., Taipei (TW)

(21) Appl. No.: 13/693,325

(22) Filed: Dec. 4, 2012

(30) Foreign Application Priority Data
Dec. 8, 2011 (TW) 100145397

(51) Int. Cl. H04W 88/02

(52) U.S. Cl. CPC H04W 88/02
USPC 455/557

(57) ABSTRACT

An electronic system and a second electronic device having the same include a first electronic device and a second electronic device. The first electronic device includes a first antenna, a control module, a connecting port and a switch module. The second electronic device includes a second antenna, a corresponding connecting port and a second antenna. When the connecting port of the first electronic device is connected to the corresponding connecting port of the second electronic device, the first electronic device switches from the first antenna to the second antenna of the second electronic device via the switch module, and the first electronic device can carry out wireless communication via the second antenna of the second electronic device.

### CROSS-REFERENCE TO RELATED APPLICATION

This application claims the priority benefit of Taiwan application serial No. 100145397, filed on Dec. 8, 2011. The entirety of the above-mentioned patent application is hereby incorporated by reference herein and made a part of specification.

### BACKGROUND OF THE INVENTION

1. Field of the Invention

The disclosure relates to an electronic system and, more particularly, to a system including an electronic device which uses hardware units of an external electronic device.

2. Description of the Related Art

Electronic devices have become more and more important in everyday life as they are small, light, and have powerful data processing and communication ability. Recently, electronic devices, such as a computer host, a tablet computer, a display or a keyboard, have more extension structures and applications. However, when the electronic device is inserted to another electronic device, an antenna of the electronic device may be shielded by an external circuit board or metal plates, resulting in bad signal transceiving.

### BRIEF SUMMARY OF THE INVENTION

A second electronic device is connected to a first electronic device which includes a first antenna. The second electronic device includes a second antenna, a corresponding connecting port and a detecting element. The detecting element detects a connection state between the corresponding connecting port and the first electronic device. When the second electronic device is connected to the first electronic device via the corresponding connecting port, the first electronic device carries out wireless communication via the second antenna of the second electronic device.

An electronic system including a first electronic device and a second electronic device is disclosed. The first electronic device includes a first antenna, a control module, a connecting port, a detecting element and a switch module. The second electronic device includes a second antenna, a detecting element and a corresponding connecting port. The detecting element detects a connection state between the corresponding connecting port and the first electronic device. When the connecting port of the first electronic device is connected to the corresponding connecting port of the second electronic device, the first electronic device switches from the first antenna to the second antenna of the second electronic device via the switch module, and carries out wireless communication via the second antenna.

The advantage of the embodiment is that after the first electronic device is connected to the second electronic device, the first electronic device can carry out wireless communication using the antenna of the second electronic device. Thus, when they are combined, the problem of bad signal transceiving due to the first antenna of the first electronic device shielded by the second electronic device can be solved.

These and other features, aspects and advantages of the present disclosure will become better understood with regard to the following description, appended claims, and accompanying drawings.

### BRIEF DESCRIPTION OF THE DRAWINGS

FIG. 1 is a block diagram showing a first electronic device in an embodiment;

FIG. 2 is a block diagram showing a second electronic device in an embodiment; and

FIG. 3 is a schematic diagram showing an electronic system including the first electronic device in FIG. 1 and the second electronic device in FIG. 2.

### DETAILED DESCRIPTION OF THE EMBODIMENTS

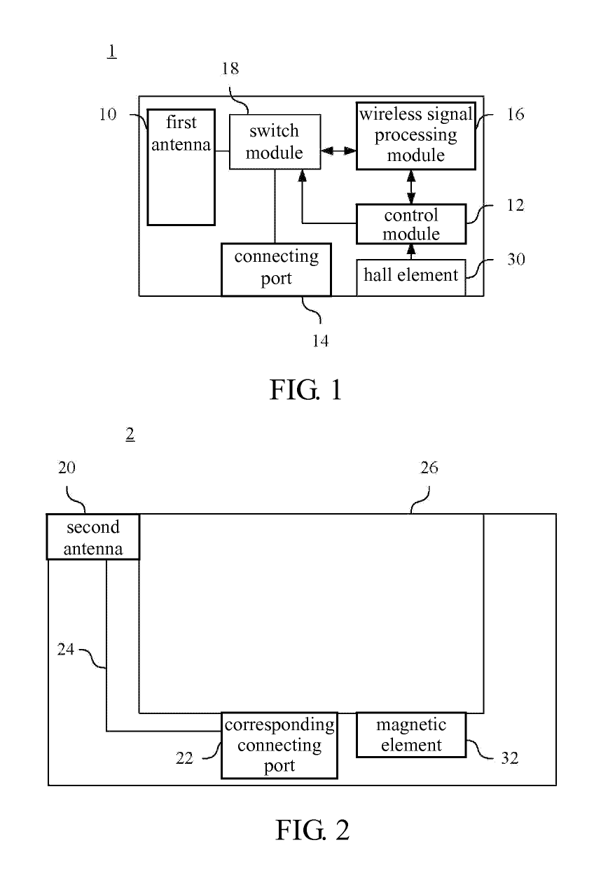

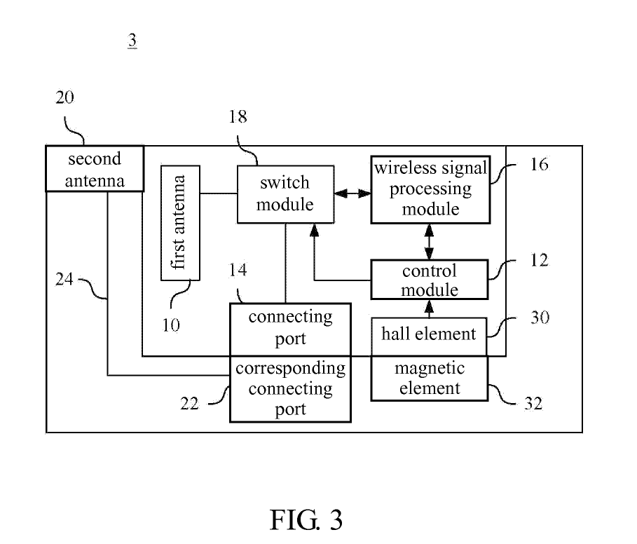

Please refer to FIG. 1, FIG. 2 and FIG. 3. FIG. 1 is a block diagram showing a first electronic device 1 in an embodiment. FIG. 2 is a block diagram showing a second electronic device 2 in an embodiment. FIG. 3 is a schematic diagram showing an electronic system 3 including the first electronic device 1 in FIG. 1 and the second electronic device 2 in FIG. 2. In the embodiment, the first electronic device 1 may be a handheld portable device, such as a mobile phone, a tablet computer or a personal digital assistant (PDA). The second electronic device 2 may be a peripheral electronic device, such as a touch control screen, which can be combined with the handheld portable device, and the user can operate the first electronic device 1 via the second electronic device 2.

The first electronic device 1 includes a first antenna 10, a control module 12, a connecting port 14, a wireless signal processing module 16 and a switch module 18.

The first electronic device 1 can carry out wireless communication via the first antenna 10. After the wireless signal processing module 16 receives a wireless signal from the first antenna 10, it downs clock, filters, decodes and transmits the processed signal to the control module 12. Similarly, the control module 12 can also transmit a signal to the wireless signal processing module 16 for encoding, filtering, up clocking and send it out via the first antenna 10.

The second electronic device 2 may be a computer host or a tablet computer which has independent calculating ability, and it may also be a device, such as a display or a keyboard, which has specific functions only when it is connected to the first electronic device 1. The second electronic device 2 includes a second antenna 20, a corresponding connecting port 22 and a transmission line 24. The transmission line 24 is connected between the second antenna 20 and the corresponding connecting port 22. In the embodiment, the second antenna 20 may be disposed at one side of the second electronic device 2 so as to avoid being shielded by a circuit board or a metal plate if it is disposed in the center.

The first antenna 10 and the second antenna 20 may be WiFi antennas, global positioning system (GPS) antennas, global system for mobile communications (GSM) antennas or bluetooth antennas, respectively, to receive and transmit corresponding wireless signals.

The first electronic device 1 can be connected to the corresponding connecting port 22 of the second electronic device 2 via the connecting port 14 to form an electronic system 3. The connecting port 14 and the corresponding connecting port 22 may be a universal serial bus (USB). The second electronic device 2 further includes a containing slot 26 for holding the first electronic device 1. However, although the first electronic device 1 can connected to the second electronic device 2 to form the electronic system 3 and extend its functions, the first antenna 10 of the first electronic device 1 is easy to be shielded by the circuit board or the metal plate of the second electronic device 2, and thus the communication efficiency is low.

The electronic system 3 may include a detecting element. In the embodiment, the detecting element includes a hall element 30 disposed in the first electronic device 1 and a magnetic element 32 disposed in the second electronic device 2. The hall element 30 and the magnetic element 32 can be disposed at the positions where induction is generated after the connecting port 14 is connected to the corresponding connecting port 22. Thus, when the hall element 30 detects the magnetic element 32, it means that the connecting port 14 is connected to the corresponding connecting port 22 (the first electronic device 1 is connected to the second electronic device), and the control module 12 is further informed. The control module 12 controls the switch module 18 to switch antennas according to the connection state between the connecting port 14 and the corresponding connecting port 22 detected by the detecting element. The detecting element may also be a firmware. When the connecting port 14 is connected to the corresponding connecting port 22, the detecting element determines whether the first electronic device 1 is connected to the second electronic device 2 and feeds back to the control module 12. The detecting element may be disposed in the first electronic device 1 or the second electronic device 2 accordingly to achieve a detection function.

When the connecting port 14 is not connected to the corresponding connecting port 22, it means that the first electronic device 1 and the second electronic device 2 are not connected. Thus, the switch module 18 connects the wireless signal processing module 16 to the first antenna 10, and the first electronic device can carry out wireless communication via the first antenna 10.

In the embodiment, when the first electronic device is connected to the second electronic device, the connecting port 14 and the corresponding connecting port 22 are connected. The switch module 18 of the first electronic device connects the wireless signal processing module 16 to the second antenna 20 via the connecting port 14, the corresponding connecting port 22 and the transmission line 24, and the first electronic device carries out wireless communication via the second antenna 20 of the second electronic device 2. Consequently, the problem that the first antenna 10 is shielded by the second electronic device 2 and the communication efficiency is low can be avoided.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A second electronic device connected to a first electronic device which includes a first antenna, the second electronic device comprising:
a second antenna;
a corresponding connecting port connected to the second antenna; and
a detecting element detecting a connection state between the corresponding connecting port and the first electronic device, wherein when the second electronic device is connected to the first electronic device via the corresponding connecting port, the first electronic device carries out wireless communication via the second antenna of the second electronic device.

2. The second electronic device according to claim 1, wherein the detecting element further includes a hall element and a magnetic element which are used for determining the connection state between the second electronic device and the first electronic device.

3. The second electronic device according to claim 1, wherein the detecting element is a firmware for determining the connection state between the second electronic device and the first electronic device.

4. The second electronic device according to claim 1, wherein the first antenna and the second antenna are WiFi antennas, global positioning system (GPS) antennas, global system for mobile communications (GSM) antennas or bluetooth antennas, respectively.

5. An electronic system, comprising:
a first electronic device including a first antenna, a control module, a connecting port, a detecting element and a switch module; and
a second electronic device including a second antenna and a corresponding connecting port connected to the second antenna;
wherein the detecting element detects the connection state between the corresponding connecting port and the first electronic device, and when the connecting port of the first electronic device is connected to the corresponding connecting port of the first electronic device, the first electronic device switches from the first antenna to the second antenna of the second electronic device via the switch module and carries out wireless communication via the second antenna.

6. The electronic system according to claim 5, wherein the detecting element further includes a hall element and a magnetic element which are disposed in the second electronic device and used for determining the connection state between the second electronic device and the first electronic device.

7. The electronic system according to claim 5, wherein the detecting element is a firmware for determining the connection state between the second electronic device and the first electronic device.

8. The electronic system according to claim 5, wherein the first electronic device further includes a wireless signal processing module and a control module, and the control module controls the switch module and determines whether the wireless signal processing module is connected to the first antenna or the second antenna for wireless communication according to the connection state detected by the detecting element.

9. The electronic system according to claim 5, wherein the first antenna and the second antenna are WiFi antennas, global positioning system (GPS) antennas, global system for mobile communications (GSM) antennas or bluetooth antennas, respectively.
